(19) United States
(12) Patent Application Publication
(10) Pub. No.: US 2019/0329870 A1
(43) Pub. Date: Oct. 31, 2019

(54) WING STRUCTURE, METHOD OF CONTROLLING WING STRUCTURE, AND AIRCRAFT

(71) Applicant: SUBARU CORPORATION, Tokyo (JP)

(72) Inventors: Hiroki KATO, Tokyo (JP); Nobuyuki NAKAZATO, Tokyo (JP); Kentaro YOSHIDA, Tokyo (JP); Maki KIKUCHI, Tokyo (JP); Tomofumi IWAMOTO, Tokyo (JP)

(73) Assignee: SUBARU CORPORATION, Tokyo (JP)

(21) Appl. No.: 16/371,931

(22) Filed: Apr. 1, 2019

(30) Foreign Application Priority Data
Apr. 25, 2018 (JP) 2018-084438

(51) Int. Cl. B64C 21/00; B64C 23/06; B64C 23/00; B64C 9/18

(52) U.S. Cl. CPC B64C 21/00; B64C 9/18; B64C 23/005; B64C 23/06

(57) ABSTRACT

A wing structure for an aircraft includes a stationary wing, a flap extendable so as to form an air flow path between the flap and the stationary wing, and at least one plasma actuator. The plasma actuator is configured to induce, while the flap is extended, air flow for suppressing or reducing separation of air on an upper surface of the flap including air flowing from a lower surface of the stationary wing to the upper surface of the flap via the flow path.

### CROSS-REFERENCE TO RELATED APPLICATIONS

The present application claims priority from Japanese Patent Application No. 2018-084438 filed on Apr. 25, 2018, the entire contents of which are hereby incorporated by reference.

### BACKGROUND

The disclosure relates to a wing structure, a method of controlling the wing structure, and an aircraft.

A flap is known as a component for controlling air flow around the main wing and tail of an aircraft (for example, Japanese Unexamined Patent Application Publication (JP-A) No. 2012-189215). The flap is a high-lift device configured to be steered during takeoff and landing of the aircraft. When an aircraft is cruising, the flap is stored inside the main wing and is extended during takeoff and landing of the aircraft. Due to the increase in the wing area and camber, extending the flap increases the lift of the wing. Note that the camber is the distance between the mean camber line and the chord line of the wing.

Further, in recent years, studies have been done on the use of plasma actuators (PA) as auxiliary devices for controlling air flow around aircraft wings (see, for example, JP-A No. 2008-290710 and JP-A No. 2016-056814). A practical application for a plasma actuator mounted on an aircraft wing is DBD-PA, which uses dielectric barrier discharges (DBD) to shape air flow.

A DBD-PA is a plasma actuator in which electrodes are disposed with a dielectric therebetween, and plasma is generated only on one side of the dielectric by applying a high-voltage alternating current between the electrodes. By using a DBD-PA, through controlling the plasma, separation of air is suppressed and air flow can be changed. As a result, by attaching DBD-PAs to wings, attempts have been made to omit movable wings such as ailerons and flaps. In other words, DBD-PAs are expected to provide an alternative to control surfaces of aircraft.

### SUMMARY

An aspect of the disclosure provides a wing structure for an aircraft including a stationary wing, a flap extendable so as to form an air flow path between the flap and the stationary wing, and at least one plasma actuator configured to induce, while the flap is extended, air flow for suppressing or reducing separation of air on an upper surface of the flap including air flowing from a lower surface of the stationary wing to the upper surface of the flap via the flow path.

An aspect of the disclosure provides an aircraft including the wing structure described above.

An aspect of the disclosure provides a method of controlling a wing structure of an aircraft. The aircraft includes a stationary wing, a flap extendable so as to form an air flow path between the flap and the stationary wing, and at least one plasma actuator. The method includes, while the flap is extended, inducing, with the at least one plasma actuator, air flow for suppressing or reducing separation of air on an upper surface of the flap including air flowing from a lower surface of the stationary wing to the upper surface of the flap via the flow path.

### BRIEF DESCRIPTION OF THE DRAWINGS

The accompanying drawings are included to provide a further understanding of the disclosure and are incorporated in and constitute a part of this specification. The drawings illustrate example implementations and, together with the specification, serve to explain the principles of the disclosure.

FIG. 1 is a cross-sectional view illustrating a configuration of a wing structure according to an embodiment of the disclosure.

FIG. 2 is a cross-sectional view illustrating a flap of the wing structure illustrated in FIG. 1 in an extended state.

FIG. 3 is a diagram illustrating a conventional slotted flap.

FIG. 4 illustrates the principle of the plasma actuator illustrated in FIG. 1.

FIG. 5 is a graph depicting a waveform of a typical burst wave.

### DETAILED DESCRIPTION

In the following, a preferred but non-limiting embodiment of the disclosure is described in detail with reference to the accompanying drawings. Note that sizes, materials, specific values, and any other factors illustrated in the embodiment are illustrative for easier understanding of the disclosure, and are not intended to limit the scope of the disclosure unless otherwise specifically stated. Further, elements in the following example embodiment which are not recited in a most-generic independent claim of the disclosure are optional and may be provided on an as-needed basis. Throughout the present specification and the drawings, elements having substantially the same function and configuration are denoted with the same reference numerals to avoid any redundant description. Further, elements that are not directly related to the disclosure are unillustrated in the drawings. The drawings are schematic and are not intended to be drawn to scale. When the camber of the main wing is increased, the angle-of-attack of the flap is controlled so as to be increased. However, if the angle-of-attack of the flap is increased, separation occurs in the trailing-edge vicinity of the flap, and the lift force may be decreased.

Therefore, in the disclosure, it is desirable to prevent the lift force from decreasing even if the angle-of-attack of the flap provided on the main wing or the like of the aircraft is increased.

### (Configurations and Functions)

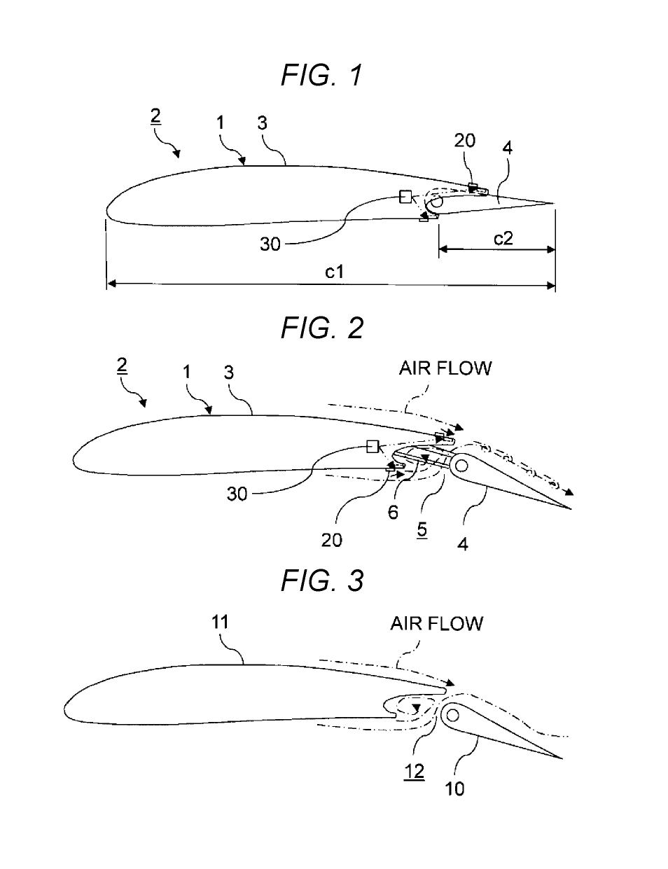

FIG. 1 is a cross-sectional view illustrating a configuration of the wing structure according to the embodiment of the disclosure, and FIG. 2 is a cross-sectional view illustrating a state in which a flap of the wing structure illustrated in FIG. 1 is extended.

A wing structure 1 is a structure such as a main wing or a tail wing of an aircraft 2. Thus, the wing structure 1 is provided in the aircraft 2. The wing structure 1 comprises a stationary wing 3 and a flap 4. The flap 4 is a high-lift device configured to be steered during takeoff and landing of the aircraft 2. Thus, the flap 4 is mainly provided in the wing structure of the aircraft 2.

The flap 4 illustrated in FIGS. 1 and 2 has an extendable structure such that an air flow path is formed between the flap 4 and the stationary wing 3. The flap 4 illustrated in FIGS. 1 and 2, having an extendable structure in which a slot 5 forms as an air flow path between the flap 4 and the stationary wing 3, is referred to as a slotted flap.

The flap 4 can be extended and stowed by an extension mechanism including an actuator 6 as exemplified in JP-A No. 7-132891. In the case of a conventional slotted flap, an actuator 6 for extending and retracting the flap 4 and an actuator 6 for controlling the steering angle of the flap 4 are provided.

While the flap 4 is extended, as illustrated in FIG. 2, air from the lower surface of the stationary wing 3 flows via the slot 5 to the upper surface of the flap 4 in addition to the air flowing from the upper surface of the stationary wing 3 to the upper surface of the flap 4. As a result, the air flowing from the upper surface the stationary wing 3 and the air flowing from the lower surface of the stationary wing 3 via the slot 5 merge together on the upper surface of flap 4. The air guided to the upper surface of the flap 4 is guided to the trailing edge of the flap 4 along the upper surface of the flap 4. As a result, an effect of suppressing separation of air on the control surface of the flap 4 is obtained.

FIG. 3 is a diagram illustrating a conventional slotted flap.

In the case of the main wing 11 provided in the conventional slotted flap 10, air flow through a slot 12 may become turbulent on the upper surface of the slotted flap 10, and separation may occur in the trailing-edge vicinity of the slotted flap 10. When such a separation of air occurs in the trailing-edge vicinity of the slotted flap 10, the steering effect of the slotted flap 10 is reduced.

Hence, the wing structure 1 is provided with at least one plasma actuator 20, as illustrated in FIGS. 1 and 2. The plasma actuator 20 is a flow control device configured to utilize plasma to induce air flow.

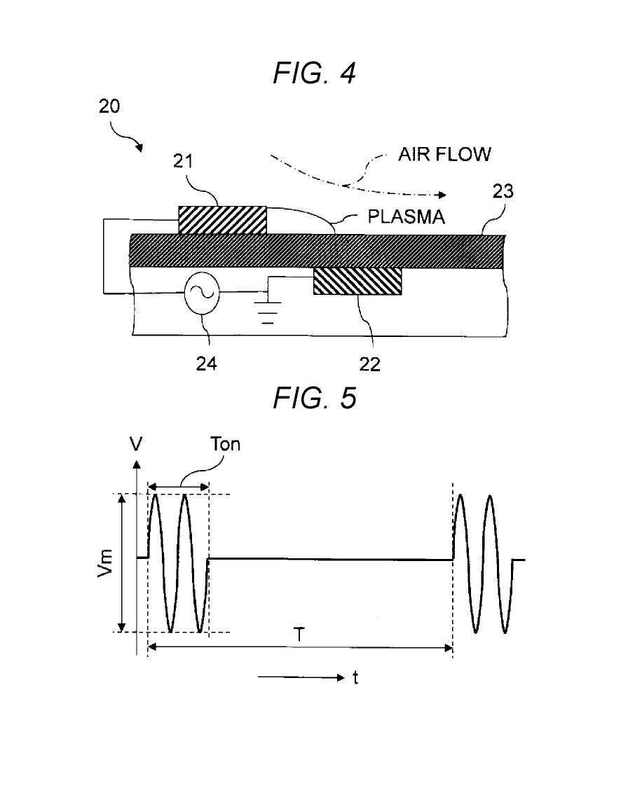

FIG. 4 is a diagram illustrating the principle of the plasma actuator 20 illustrated in FIG. 1.

The plasma actuator 20 includes a first electrode 21, a second electrode 22, a dielectric 23, and an alternating current (AC) power supply 24. The first electrode 21 and the second electrode 22 are disposed so as to be shifted with respect to each other with the dielectric 23 interposed therebetween to form a discharge area. The first electrode 21 is disposed so as to be exposed to a space in which air flow is to be induced. On the other hand, the second electrode 22 is covered with the dielectric 23 so as not to be exposed to the space where air flow is to be induced. The second electrode 22 is grounded to the airframe of the aircraft 2. An AC voltage is applied between the first electrode 21 and the second electrode 22 by an AC power supply 24.

When the AC power supply 24 is operated to apply an AC voltage between the first electrode 21 and the second electrode 22, plasma composed of electrons and positive ions is generated in a discharge area formed on the surface of the dielectric 23 on the side where the first electrode 21 is disposed. As a result, air flow toward the surface of the dielectric 23 is induced by the plasma. The plasma actuator 20, which causes a dielectric barrier discharge by interposing the dielectric 23 between the first electrode 21 and the second electrode 22, is called a dielectric barrier discharge plasma actuator, or DBD-PA.

The first electrode 21 and the second electrode 22 constituting the plasma actuator 20 may each be in the form of a thin film. Therefore, the plasma actuator 20 can be used by being attached to the surface of the wing structure 1 or embedded in a surface layer serving as an attachment position.

The plasma actuator 20 then induces an air flow to suppress or reduce separation of air on the upper surface of the flap 4, including air flowing from the lower surface of the blade 3 to the upper surface of the flap 4 via the slot 5. That is, by the merging of air flowing from the lower surface of the stationary wing 3 via the slot 5 and air flowing from the upper surface of the stationary wing 3, separation of the air flow formed on the upper surface of the flap 4 is suppressed or reduced by the air flow induced by the plasma actuator 20.

Specifically, as illustrated in FIG. 2, it is effective to generate an air vortex for suppressing or reducing separation of air on the upper surface of the flap 4 with the plasma actuator 20. That is, by generating an air vortex on the upper surface of the flap 4, it is possible to suppress or reduce separation of air in the trailing-edge vicinity of the flap 4. The air vortex can be generated by disturbing the shear air flow occurring at the trailing edge of the stationary wing 3.

The number and disposition of the plasma actuators 20 for effectively suppressing or reducing separation of air at the trailing-edge of the flap 4 can be determined by wind tunnel tests or simulations. Thus, the plasma actuators 20 can be provided at desired positions on the wing structure 1 having the stationary wing 3 and the flaps 4. In particular, if a plasma actuator 20 is disposed on a part where the air is away from the surface of the stationary wing 3, it is possible to effectively generate an air vortex for suppressing or reducing separation.

Therefore, depending on the result of the wind tunnel test or simulation, a plasma actuator 20 may be disposed at least at the trailing edge on the upper surface of the stationary wing 3, or a plasma actuator 20 may be disposed at least at the trailing edge on the lower surface of the stationary wing 3. By disposing a plasma actuator 20 at the trailing edge on the upper surface of the stationary wing 3, it is possible to induce air flow for controlling the air flowing mainly from the upper surface of the stationary wing 3 to the upper surface of the flap 4. On the other hand, by disposing the plasma actuator 20 at the trailing edge on the lower surface of the stationary wing 3, it is possible to induce air flow for controlling the air flowing mainly from the lower surface of the stationary wing 3 to the upper surface of the flap 4 via the slot 5.

In the example illustrated in FIGS. 1 and 2, the plasma actuators 20 are disposed at both the trailing edge on the upper surface of the stationary wing 3 and the trailing edge on the lower surface of the stationary wing 3. As a result, the air flowing from the upper surface of the stationary wing 3 to the upper surface of the flap 4 can be controlled by operating the plasma actuator 20 disposed at the trailing edge on the upper surface of the stationary wing 3, while the air flowing from the lower surface of the stationary wing 3 to the upper surface of the flap 4 via the slot 5 can be controlled by operating the plasma actuator 20 disposed at the trailing edge on the lower surface of the stationary wing 3. As a result, separation of air on the upper surface of the flap 4 can be effectively suppressed or reduced.

For generating vortices by actuating a plasma actuator 20, tests have shown that intermittent actuation of a plasma actuator 20 is effective. In order to intermittently operate the plasma actuator 20, it is effective to make the AC voltage waveform applied by the AC power supply 24 between the first electrode 21 and the second electrode 22 of the plasma actuator 20 a burst wave.

FIG. 5 is a graph illustrating a waveform of a typical burst wave.

In FIG. 5, the vertical axis represents voltage V, and the horizontal axis represents time t. As illustrated in FIG. 5, the burst wave is a wave consisting of a period in which the amplitude changes and a period in which the amplitude does not change, the burst wave having a cycle that is repeated with a constant burst period T. Accordingly, when the waveform of the AC voltage is a burst wave, the period Ton in which the AC voltage of the amplitude Vm is continuously applied is intermittently repeated with a burst period T. The ratio Ton/T of the period Ton, in which the AC voltage is applied, to the burst period T corresponds to the duty ratio and is called a burst ratio BR.

Therefore, waveform parameters, such as a burst period T and a burst ratio BR, which are suitable for forming a target air flow by operation of the plasma actuator 20, can be obtained in advance by wind tunnel tests or simulations and may be stored in a database. That is, the control device 30 of the plasma actuator 20 may be provided with a storage device for storing information, such as a table or a function indicating relationships between air flow formed by operation of the plasma actuator 20 and AC voltage waveforms applied between the first electrode 21 and the second electrode 22 of the plasma actuator 20. Thus, the waveform of the AC voltage applied between the first electrode 21 and the second electrode 22 of the plasma actuator 20 can be automatically controlled by the control device 30 composed of an electronic circuit or the like.

When the burst frequency f, which is the inverse of the burst period T, or the burst period T, is nondimensionalized and a wind tunnel test or a simulation is performed, it is possible to determine an appropriate burst period T or burst frequency f by a shared wind tunnel test or simulation, even if the shape of the wing structure 1 including the flap 4 or the air flow velocity is different. For example, the burst frequency f can be made dimensionless by referencing to the chord length c1 of the wing structure 1 or the control surface length c2 of the flap 4, which is defined as illustrated in FIG. 1, and the main air flow velocity U.

Specifically, the burst frequency F1, which is nondimensionalized by the chord length c1 of the wing structure 1 and the main air flow velocity U, is expressed by Equation (1).

F1=(1/T)/(U/c1)=f/(U/c1) (1)

On the other hand, the burst frequency F2, which is nondimensionalized by the control surface length c2 of the flap 4 and the main air flow velocity U, is expressed by Equation (2).

F2=(1/T)/(U/c2)=f/(U/c2) (2)

Accordingly, it is possible to determine the AC voltage waveform to be applied between the first electrode 21 and the second electrode 22 of the plasma actuator 20 as a burst waveform with the burst frequency F1, F2 or burst period, which is nondimensionalized by the chord length c1 or the control surface length c2 of the flap 4 of the wing structure 1, composed of the flap 4 and the stationary wing 3. This makes it possible to determine the shared nondimensionalized burst frequency F1, F2 or the burst period independently of the chord length c1 of the wing structure 1 or the control surface length c2 of the flap 4. Also, by nondimensionalizing the main air flow velocity U, the shared nondimensionalized burst frequency F1, F2 or burst period can be determined regardless of the main air flow velocity U.

The control device 30 may then be configured to automatically operate the plasma actuator 20 when the flap 4 is extended and the slot 5 is formed. That is, extending the flap 4 by driving the actuator 6 provided in the extension mechanism and the operation of the plasma actuator 20 can be performed in conjunction under the control of the control device 30. When the plasma actuator 20 is operated, a control signal can be outputted from the control device 30 to the AC power supply 24 so that an AC voltage having an appropriate waveform such as a burst wave is applied between the first electrode 21 and the second electrode 22 by the AC power supply 24 of the plasma actuator 20. Of course, the operator of the aircraft 2 may manually switch the plasma actuator 20 between the ON state and the OFF state.

The wing structure 1, the method of controlling the wing structure 1, and the aircraft 2 as described above are configured to have the flap 4 having such an extendable structure that the slot 5 is formed as the air flow path between the flap 4 and the stationary wing 3, and induce air flow for suppressing or reducing separation of air on the upper surface of the flap 4, including the air flowing from the lower surface of the stationary wing 3 to the upper surface of the flap 4 via the slot 5 by using at least one plasma actuator 20 while the flap 4 is extended.

### (Effect)

With the wing structure 1, the control method of the wing structure 1, and the aircraft 2, even when the angle-of-attack of the flap 4 is increased, the separation of air at the trailing edge of the flap 4 can be suppressed and higher lift can be obtained. As a result, it is possible to downsize the flap 4 itself and the aircraft 2 can take off and land at a lower speed. If the aircraft 2 can take off and land at low speed, it will also be possible to shorten the length of the runway required for the aircraft 2 to take off and land.

If the plasma actuator 20 is attached to the stationary wing 3, heavy objects such as the AC power supply 24 required to drive the plasma actuator 20 can be accommodated on the stationary wing 3 which is more rigid than the flap 4, which has a cantilever structure.

### Other Embodiments

While a specific example has been described above, the described embodiment is by way of example only and is not intended to limit the scope of the disclosure. The novel methods and apparatus described herein may be demonstrated in a variety of other manners. Various omissions, substitutions, and changes may be made in the manner of the methods and apparatus described herein without departing from the spirit of the disclosure. The appended claims and their equivalents include such various forms and modifications as fall within the scope and spirit of the disclosure.

1. A wing structure for an aircraft, comprising:
a stationary wing,
a flap extendable so as to form an air flow path between the flap and the stationary wing, and
at least one plasma actuator configured to induce, while the flap is extended, air flow for suppressing or reducing separation of air on an upper surface of the flap including air flowing from a lower surface of the stationary wing via the flow path to the upper surface of the flap.

2. The wing structure according to claim 1, wherein the at least one plasma actuator is configured to generate an air vortex for suppressing or reducing the separation of air.

3. The wing structure according to claim 2, wherein the at least one plasma actuator is configured to generate the air vortex by disturbing shear air flow generated at a trailing edge of the stationary wing.

4. The wing structure according to claim 1, wherein the at least one plasma actuator is disposed at least at a trailing edge on the upper surface of the stationary wing and induces air flow to control air flowing from the upper surface of the stationary wing to the upper surface of the flap.

5. The wing structure according to claim 2, wherein the at least one plasma actuator is disposed at least at a trailing edge on the upper surface of the stationary wing and induces air flow to control air flowing from the upper surface of the stationary wing to the upper surface of the flap.

6. The wing structure according to claim 3, wherein the at least one plasma actuator is disposed at least at a trailing edge on the upper surface of the stationary wing and induces air flow to control air flowing from the upper surface of the stationary wing to the upper surface of the flap.

7. The wing structure according to claim 1, wherein the at least one plasma actuator is disposed at least at a trailing edge on the lower surface of the stationary wing and induces air flow to control air flowing from the lower surface of the stationary wing to the upper surface of the flap via the flow path.

8. The wing structure according to claim 2, wherein the at least one plasma actuator is disposed at least at a trailing edge on the lower surface of the stationary wing and induces air flow to control air flowing from the lower surface of the stationary wing to the upper surface of the flap via the flow path.

9. The wing structure according to claim 3, wherein the at least one plasma actuator is disposed at least at a trailing edge on the lower surface of the stationary wing and induces air flow to control air flowing from the lower surface of the stationary wing to the upper surface of the flap via the flow path.

10. An aircraft comprising the wing structure according to claim 1.

11. An aircraft comprising the wing structure according to claim 2.

12. An aircraft comprising the wing structure according to claim 3.

13. A method of controlling a wing structure of an aircraft, the aircraft comprising a stationary wing, a flap extendable so as to form an air flow path between the stationary wing and the flap and at least one plasma, the method comprising
while the flap is extended, inducing, with the at least one plasma actuator, air flow for suppressing or reducing separation of air on an upper surface of the flap including air flowing from a lower surface of the stationary wing to the upper surface of the flap via the air flow path.

14. The method of controlling a wing structure according to claim 7, further comprising
determining an alternating current voltage waveform to be applied between electrodes of the plasma actuators
as a burst waveform having a burst frequency or a burst period, which is nondimensionalized by a control surface length of the flap or a chord length of the wing structure.
